(19) United States
(12) Patent Application Publication
(10) Pub. No.: US 2009/0094325 A1
(43) Pub. Date: Apr. 9, 2009

(54) Acuro Universal Multimedia Communication System (AUMCS)

(76) Inventors: Snehal Karia, Fremont, CA (US); Jeffrey Lo, East Palo Alto, CA (US); Dickson Chan, Fremont, CA (US); Satish Salagame, Sunnyvale, CA (US); Danny W. Qian, Fremont, CA (US)

Correspondence Address: STEVEN A. NIELSEN;ALLMAN & NIELSEN, P.C, 100 Larkspur Landing Circle, Suite 212, LARKSPUR, CA, 94939, US

(21) Appl. No.: 12/248,501

(22) Filed: Oct. 9, 2008

Related U.S. Application Data
(60) Provisional application No. 60/978,656, filed on Oct. 9, 2007.

(51) Int. Cl. G06F 15/16

(52) U.S. Cl. 709/203

(57) ABSTRACT

A global multimedia server, local multimedia server and multimedia client create a universal communication system allowing any consumer to engage a plethora of media content to any end user. The global media server may be located through a publicly accessible IP address using a FQDN (fully qualified domain name) based on DNS. The delivery of multimedia calls or messages may also be achieved by using an E.164 number as universal resource identifier. PBX features allow for the manipulation of multimedia content and the use of mixed and multiple media during a communication or the creation of spontaneous or scheduled conferences that are both collaborative and interactive.

### RELATED PATENT APPLICATION AND INCORPORATION BY REFERENCE

This is a utility application based upon U.S. patent application Ser. No. 60/978,656 entitled “Acuro Universal Multimedia Communication System (AUMCS™),” filed on Oct. 9, 2007. This related application is incorporated herein by reference and made a part of this application. If any conflict arises between the disclosure of the invention in this utility application and that in the related provisional application, the disclosure in this utility application shall govern. Moreover, the inventors incorporate herein by reference any and all patents, patent applications, and other documents hard copy or electronic, cited or referred to in this application.

### COPYRIGHT AND TRADEMARK NOTICE AUMCS™ ACURO™

This application includes material which is subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### BACKGROUND OF THE INVENTION

(1) Field of the Invention

The invention generally relates multimedia communication methods. More specifically, the invention relates to means and methods of delivery of multimedia to home and mobile consumers.

(2) Description of the Related Art

The transmission of communications in the related art is currently shifting from POTS/PSTN (Plain Old Telephone Service/Public Switched Telephone Network) to VoIP (Voice over Internet Protocol). The WWW (World Wide Web) is shifting from being an internet application to being a platform for global communication in various types of media. The increase of online consumers and consumers of mobile equipment has resulted in the related art creating a plethora of communication tools such as email, IM, voice telephony using fixed line and mobile wireless technologies. For large business entities PBX, audio and video conferencing and other collaboration solutions may be found in the related art. The related art suffers from numerous shortfalls and fails to provide effective and user friendly means of transmitting mixed multimedia content to or from home or mobile consumers.

### BRIEF SUMMARY OF THE INVENTION

The present invention overcomes shortfalls in the related art by presenting several unobvious and unique methodologies that achieve unexpected results by providing a complete and seamless consumer oriented multimedia communication system. The principles of the invention are sometimes labeled or called the Acuro Universal Multimedia Communication System or AUMCS. The principles or goals of the invention are executed through or by the following components, comprising:

1. A global multimedia server, sometimes called the Acuro global multimedia server or “AGMS”;

2. A local multimedia server, sometimes called the Acuro local multimedia server or “ALMS”; and

3. A multimedia client, sometimes called the Acuro multimedia client or “AMC”.

The invention overcomes shortfalls in the art by providing means and methods of transmitting, receiving, storing and manipulating multimedia messages or calls that may comprise multimedia sources, have multiple endpoints and multiple parties. The disclosed system may present multiple windows and a graphical user interface “GUI” to facilitate multiparty sessions that are interactive and collaborative. PBX like features are integrated into the consumer interface even though a user of the system on the client side may be using an electronic portable device “PDE” or a typical laptop or desktop computer.

The invention overcomes shortfalls in the related art by presenting new systems and methodologies of creating and using a global unique resource identifier.

The invention provides many advantages over the related art, including, but not limited to:

1. Enabling users of the disclosed system to place and receive multimedia calls or messages using an existing home telephone or television set, the two most common electronic devices in modern households. The related art requires the purchase of new dedicated hardware, the acquisition of evolving software and often complex and difficult configuration of the hardware and software that is often beyond the ability or patience of the average consumer. The related art fails to pass the “Grandmother Test” wherein a typical grandmother will be able to place or receive multimedia calls.

2. Enabling users to place and receive multimedia calls or messages from or to any electronic endpoint, including but not limited to, a home phone, mobile phone, personal computer “PC”, television “TV” or EDA.

3. Enabling users to create, manipulate, receive and transmit multiple forms of media during a call or transmission. The system will accept media content from all known electronic devices, including but not limited to, webcams, camcorders, digital cameras, EDA's, CD/DVD players.

4. Providing users with a robust set of multimedia Private Branch Exchange “PBX” features for seamlessly integrated multimedia sharing, interactivity and collaboration before, during and after a conference.

5. Providing users with a simple and intuitive interface that may be quickly and effortlessly mastered by the typical consumer or Grandmother.

These and other objects and advantages will be made apparent when considering the following detailed specification when taken in conjunction with the drawings.

### BRIEF DESCRIPTION OF THE DRAWINGS

FIG. 1 is a block diagram of network architecture of a multimedia system with a design consistent with the principles of the present invention.

FIG. 2 is a block diagram of mobile multimedia client architecture designed a in a manner consistent with the principles of the invention.

FIG. 3 is a block diagram of multimedia PC/Web architecture designed in a manner consistent with the principles of the invention.

FIG. 4 is a block diagram of an Acuro global multimedia server (AGMS) designed a in a manner consistent with the principles of the invention.

FIG. 5 is a block diagram of an Acuro local multimedia server (ALMS)

### REFERENCE NUMERALS IN THE DRAWINGS

100 Acuro global multimedia server (AGMS)

150 Acuro global multimedia server (AGMS) architecture

151 Configuration and database manager

152 Database

153 XML/SOAP interface

154 Acuro multimedia global engine

155 IMS/carrier Interface

156 Client interface

157 ALMS Manager

158 HTTP/Web Interface

159 Video/image interface

160 Voice Interface

161 Connection layer (TCP/IP, sockets, HTTP, SIP)

200 Acuro multimedia client (AMC) in an example for a mobile client

250 Acuro multimedia client architecture or an Acuro multimedia client (AMC)

251 Graphical user interface (GUI)

252 Session manager

253 Acuro multimedia core engine

254 Local application interface

255 Networking and operating system services

256 CDC

257 WiFi

258 VoIP

259 Telephone application programming TAPI

300 Acuro multimedia server (ALMS)

310 Acuro local multimedia server (ALMS) architecture

311 HTTP, TCP/IP and UDP/IP

312 Security

313 Configuration and database manager

314 Database

315 SIP and RTSP

316 PBX

317 Resource manager

318 Mobility manager

319 Session manager

320 Multimedia call control

321 Connection Manager

322 AGMS Interface

323 Pkt/RTP

324 Mux Demux

325 video processing

326 PSTN/TDM

327 Audio processing

328 Drivers and hardware management APIs

329 Hardware—CPU/GPU, FPGA, DSP, Audio/Video/Telephony/IR/Network connectors

350 PC/web Acuro multimedia client “AMC” architecture

351 GUI

352 Session Manager

353 Acuro Multimedia Core Engine

355 Networking and operating system services

358 VoIP

359 Security

360 W/LAN

400 Local Area Network (LAN)

401 Personal computer (PC)

402 Television (TV)

403 Web cam

404 Phone

405 DVD

500 Internet

501 Cellular network

502 Public switched telephone network (PSTN)

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals or reference numbers throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

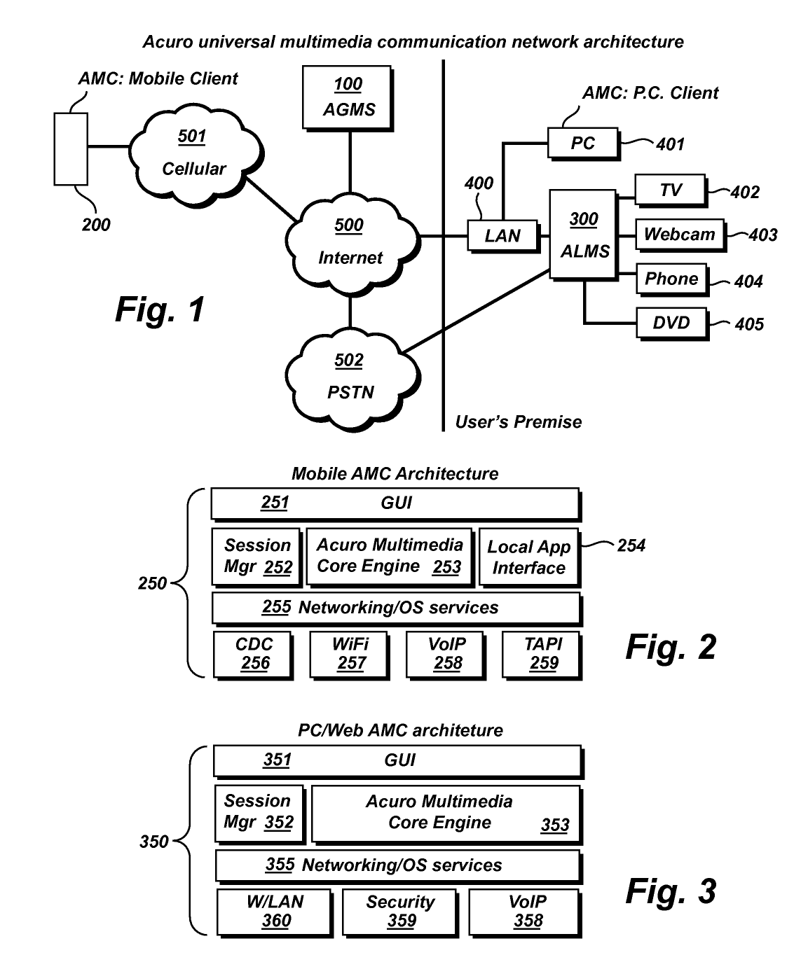

Referring to FIG. 1 the Acuro universal multimedia communication network architecture is shown generally in an example wherein a local multimedia server of the Acuro multimedia server 300 is installed into a users home or abode and is connected to the Internet 500 via a Public Switched Telephone Network or “PSTN” 502, from the Internet 500 the call or message may travel through a private cellular network 501 before reaching a mobile client 200. Alternatively or simultaneously, the message or call may travel from the ALMS 300 and be transmitted through a router or switch to a local area network or LAN 400 and then travel to the Internet 500 at large.

The ALMS 300 may interface and interact with a plethora of peripheral equipment such as a TV 402, Webcam 403 Phone 404 or DVD player 405. A personal computer “PC” 401 may interface with the ALMS 300 though a LAN 400. The PC may provide monitor or other means of visual output. The ALMS 300 may interface with the Acuro global media server “AGMS” architecture (150 of FIG. 4) and other ALMS systems over the Internet using UDP/TCP/IP based protocols include but not limited to HTTP/S, TLS/SSL, SIP/RTSP and RTP.

The AGMS 150 or AGMS architecture may be used as a portal and may be used to manage users and services related CRUD (create, retrieve, update, delete), databases for users, groups, contacts, etc. AGMS 150 may also communicate with each ALMS 310 system to provide presence and signaling, NAT traversal and signaling relay, and in some cases media relay. The AGMS 150 also manages ALMS 310 and MM client software images, provides real time and non real time statistics, debugging and logging facilities as well as interfaces with other 3^{rd} party services including but not limited to: audio services, video services, text and instant messaging services, video/web conferencing services, IMS services, and other SOA, web- and XML-based services. The AGMS 150 may be responsible for system and feature order processing, online and offline support, forums, documentation, developers' network and many other web- and voice/IVR-based features.

The AMC 250 or 350 interacts directly with ALMS 310 when the device carrying the client is on premise. When the device is outside the reach of ALMS, then AMC interacts with ALMS through AGMS or directly with AGMS to specify its network availability, preferences and limitations related to multimedia calls, and to exchange other pieces of information.

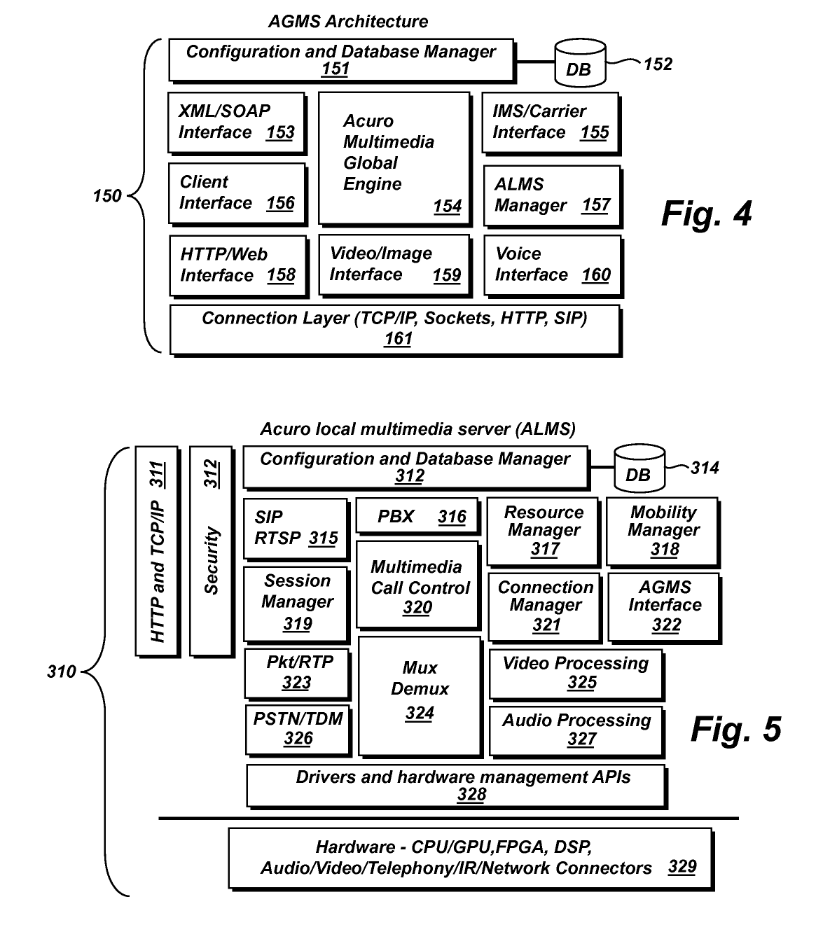

An example of the Acuro multimedia client architecture for a mobile device is shown generally in FIG. 2. An example of the Acuro multimedia client architecture for a personal computer is shown generally in FIG. 3.

Referring to FIG. 2, mobile AMC architecture is shown generally 250 in four layers, the first layer comprising a GUI 251, the second layer comprising a session manager 252, an Acuro multimedia core engine 253, and a local application interface 254, the third layer comprising networking and operating system services 255 and the forth layer comprising CDC 256, WiFi 257, VoIP 258, and TAPI 259.

Referring to FIG. 3, PC/Web AMC architecture is shown generally 350 in four layers, the layers comprising a first layer comprising a GUI 351, a second layer comprising a session manager 352 and a Acuro multimedia core engine 353, a third layer comprising networking and operating system services 355 and a forth layer comprising a wired or wireless LAN 360, security software, 359 and VoIP 358.

For both the mobile AMC architecture 250 and the PC/Web AMC architecture 350: The Acuro Multimedia Client is a software entity which resides on any Java/BREW enabled device, any other mobile device having a programmable operating system such as Blackberry, Windows Mobile, Symbian, Linux, a PC with Windows, Macintosh, Linux or other desktop OS or in a web browser and the disclosed AMCs securely communicate with either ALMS or AGMS and maintain a session. The session is managed by a session manager module. A mobile client can communicate over cellular data channel including but not limited to: GRPS or EV-DO for data communication. If WLAN/WiFi is available, then it is preferred over cellular data. Similarly, VoIP is preferred for voice communication. If VoIP is not available, the normal telephony network is utilized via TAPI.

The AMC multimedia core engine 253 or 353 receives and manages most of the information related to the users' communication needs. It presents the information to the GUI layer for customized presentation.

Referring to FIG. 4 an example of Acuro global multimedia server (AGMS) architecture 150 is shown in a configuration of five layers, the layers comprising, a configuration and database manager 151 and a database 152, a second layer comprising a XML/SOAP interface 153 an Acuro multimedia global engine 154 (in both second and third layers) and an IMS/Carrier Interface 155 and a third layer comprising a client interface 156 an Acuro multimedia global engine 154 (in both second and third layers) and an ALMS manager 157; a forth layer comprising a HTTP/Web interface 158, a video image interface 159 and a voice interface 160; and a forth connection layer 161 comprising TCP/IP, Sockets, HTTP, and SIP.

The disclosed AGMS 150 may be used to provide updated versions of client and ALMS images, user authentication and authorization and preferences, licensing and other functions as described herein. Based on the security policies, the AGMS can act as a proxy/relay for the clients.

Referring to FIG. 5 the disclosed Acuro local multimedia server “ALMS” 310 is shown in seven layers, the layers comprising Http and UDP/TCP/IP 311 and security 312 residing in layers 1, 2, and 3; a first layer comprising a configuration and database manager 312 and a database 314; a second layer comprising a SIP/RTSP 315, a PBX 316, multimedia call control 320 (in both the second and third layer), a resource manager 317 and a mobility manager 318; a third layer comprising a session manager 319, multimedia call control 320, a connection manager 321 and a AGMS interface 322; a fourth layer comprising Pkt/RTP 323, Mux Demux 324, video processing; a fifth layer comprising PST/TDM 326, Mux Demux 324, audio processing 327; a sixth layer comprising drivers and hardware management APIs 328 and a seventh layer or group of components comprising hardware—CPU/GPU,FPGA, DSP, Audio/Video/Telephony/IR/Network Connectors 329.

The ALMS 310 may be used to provide connectivity with the various communication components available to the user. The ALMS may be used to initiate, terminate and maintain multimedia call sessions, provide menu driven user options and provide calling features before, during and after the call.

To add simplicity and efficiency to the system and to counter act the unbridled consumption of traditional identifiers such as email ID and phone numbers, the disclosed system may include the unique feature of using an E.164 number as the Unique Resource Identifier “URI”. The invention also includes the use of PSTN NAT as a URI.

Multimedia PBX 316 is found within the second layer of ALMS 310 and offers PBX like features for all forms of media. For example, a user can create a multimedia “MM” call, forward, hold, transfer the call to another user, add or switch media source, mix multiple media during the call or create an ad-hoc or scheduled collaborative, interactive MM conference. All of these functions may be exercised among users who can be using any type of endpoint device, such as a home phone+TV/Monitor, web/PC or mobile device, regardless of what type of media each endpoint supports. For example, a user can also create a MM IVR, MM ring tone, MM ring back tone and MM messages.

Items

The principles of the present invention include, but are not limited to the items described below:

Item 1: A multimedia communication system, the system comprising:
a) a global multimedia server or AGMS 100;
b) a local multimedia server or ALMS 300; and
c) a multimedia client or AMC 250.

Item 2: The system of item 1 wherein an E.164 number is used as the unique resource identifier is targeting and delivering communications to and from a user of the system.

Item 3: The system of item 1 wherein:
a) the global multimedia server architecture 150 or AGMS 100 comprises five layers:
   i. the first layer comprising a configuration and database manager 151 and a database 152, a second layer comprising a XML/SOAP interface 153 an Acuro multimedia global engine 154 (in both second and third layers) and an IMS/Carrier Interface 155 and a third layer comprising a client interface 156 an Acuro multimedia global engine 154 (in both second and third layers) and an ALMS manager 157; a forth layer comprising a HTTP/Web interface 158, a video image interface 159 and a voice interface 160; and a forth connection layer 161 comprising TCP/IP, Sockets, HTTP, and SIP.
b) the local multimedia server or ALMS 300 has an architecture comprising seven layers:
   i. with the layers comprising Http and TCP/IP 311 and security 312 residing in layers 1, 2, and 3; a first layer comprising a configuration and database manager 312 and a database 314; a second layer comprising a SIP RTSP 315, a PBX 316, multimedia call control 320 (in both the second and third layer), a resource manager 317 and a mobility manager 318; a third layer comprising a session manager 319, multimedia call control 320, a connection manager 321 and a AGMS interface 322; a fourth layer comprising Pkt/RTP 323, Mux/Demux 324, video processing; a fifth layer comprising PST/TDM 326, Mux/Demux 324, audio processing 327; a sixth layer comprising drivers and hardware management APIs 328 and a seventh layer or group of components comprising hardware—CPU/GPU,FPGA, DSP, Audio/Video/Telephony/IR/Network Connectors 329.
c) the local multimedia client 250 is mobile and has an architecture comprising four layers:
   i. the first layer comprising a GUI 251, the second layer comprising a session manager 252, an Acuro multimedia core engine 253, and a local application interface 254, the third layer comprising networking and operating system services 255 and the forth layer comprising CDC 256, WiFi 257, VoIP 258, and TAPI 259.

Item 4: The system of item 3 wherein the local multimedia client is PC and internet based 350 and has an architecture comprised of four layers, comprising:
i. a first layer comprising a GUI 351, a second layer comprising a session manager 352 and a Acuro multimedia core engine 353, a third layer comprising networking and operating system services 355 and a forth layer comprising a wired or wireless LAN 360, security software, 359 and VoIP 358.

We claim:

1. A multimedia communication system, the system comprising:
a) a global multimedia server;
b) a local multimedia server; and
c) a multimedia client.

2. The system of claim 1 wherein an E.164 number is used as the unique resource identifier is targeting and delivering communications to and from a user of the system.

3. The system of claim 1 wherein:
a) the global multimedia server is comprised of architecture comprising five layers:
i. the first layer comprising a configuration and database manager and a database; a second layer comprising a XML/SOAP interface, an Acuro multimedia global engine (in both second and third layers) and an IMS/Carrier Interface; aa third layer comprising a client interface, an Acuro multimedia global engine (in both second and third layers) and an ALMS manager; a forth layer comprising a HTTP/Web interface, a video image interface and a voice interface; and a forth connection layer comprising TCP/IP, Sockets, HTTP, and SIP.
b) the local multimedia server is comprised of architecture comprising seven layers:
i. Http and TCP/IP and security residing in layers 1, 2, and 3; a first layer comprising a configuration and database manager and a database; a second layer comprising a SIP RTSP, a PBX, multimedia call control (in both the second and third layer), a resource manager and a mobility manager; a third layer comprising a session manager, multimedia call control, a connection manager and a AGMS interface; a fourth layer comprising Pkt/RTP, Mux/Demux, video processing; a fifth layer comprising PST/TDM, Mux/Demux, audio processing; a sixth layer comprising drivers and hardware management APIs; and a seventh layer or group of components comprising hardware, the hardware comprising CPU/GPU,FPGA, DSP, and Audio/Video/Telephony/IR/Network Connectors.
c) the local multimedia client is mobile and comprises an architecture comprising four layers:
i. the first layer comprising a GUI, the second layer comprising a session manager, an Acuro multimedia core engine, and a local application interface; the third layer comprising networking and operating system services; and the forth layer comprising CDC, WiFi, VoIP, and TAPI.

4. The system of claim 3 wherein the local multimedia client resides in a personal computer, is internet based and a has an architecture comprised of four layers, the layers comprising:
i. a first layer comprising a GUI; a second layer comprising a session manager and a Acuro multimedia core engine; a third layer comprising networking and operating system services; and a forth layer comprising a wired or wireless LAN, security software and VoIP.
